(19) United States
(12) Patent Application Publication
(10) Pub. No.: US 2012/0056948 A1
(43) Pub. Date: Mar. 8, 2012

(54) Solution storage tank and inkjet printer head assembly with the same

(75) Inventors: Jae Hun Kim, (US); Sung Nam Cho, (US); Ji Han Kwon, (US); Ha Yoon Song, (US)

(73) Assignee: Samsung Electro-Mechanics Co., Ltd., Suwon (KR)

(21) Appl. No.: 12/929,575

(22) Filed: Feb. 1, 2011

(30) Foreign Application Priority Data
Sep. 2, 2010 (KR) 10-2010-0086063

(51) Int. Cl. B41J 2/175

(52) U.S. Cl. 347/85

(57) ABSTRACT

Disclosed herein is an inkjet printer head assembly. The inkjet printer head assembly according to exemplary embodiments of the present invention includes: a storage unit having an inner space in which a solution is stored; a fluid supplier supplying fluid to the storage unit; and an agitator provided in the storage unit and driven by the fluid supplied to the storage unit from the fluid supplier to agitate the solution.

### CROSS REFERENCE TO RELATED APPLICATIONS

This application claims the benefit under 35 U.S.C. Section [120, 119, 119(e)] of Korean Patent Application Serial No. 10-2010-0086063, entitled “Solution Storage Tank And Inkjet Printer Head Assembly With The Same” filed on Sep. 2, 2010, which is hereby incorporated by reference in its entirety into this application.

### BACKGROUND OF THE INVENTION

1. Technical Field

The present invention relates to a solution storage tank and an inkjet printer head assembly with the same, and more particularly, to a solution storage tank capable of improving storage and supply efficiency of ink and stability in use and an inkjet printer head assembly with the same.

2. Description of the Related Art

Recently, a technology of implementing images using an inkjet printer has been prevalently used. A study for applying an inkjet printer technology to a manufacturing process of a color filter, a solar cell battery, an organic light emitting display (OLED), and a printed circuit board (PCB) has been recently conducted.

At present, a representatively used inkjet printer includes an inkjet printer head assembly discharging ink. The inkjet printer head assembly largely includes an ink tank package and a nozzle package combined with the ink tank package. The ink tank package includes a storage tank storing ink and a fluid supplier supplying ink to the storage tank. The nozzle package includes a nozzle plate finally discharging ink supplied from the ink tank package to printing objects.

In this configuration, the storage tank is continuously stored with ink but causes precipitation of ink, thereby deteriorating the discharge efficiency of ink. In order to solve the problem, the ink tank requires an apparatus capable of agitating ink; however, the inkjet printer is very sensitive to vibrations. As a result, the inkjet printer has a limitation in including components generating vibrations, such as the agitator, etc.

### SUMMARY OF THE INVENTION

An object of the present invention is to provide a solution storage tank capable of agitating a solution in a non-vibration manner and an inkjet printer head assembly with the same.

Another object of the present invention is to provide a solution storage tank capable of improving agitation efficiency of a solution and an inkjet printer head assembly with the same.

According to an exemplary embodiment of the present invention, there is provided a solution storage tank, including: a storage unit having an inner space in which a solution is stored; a fluid supplier supplying fluids to the storage unit; and an agitator provided in the storage unit and driven by the fluids supplied to the storage unit from the fluid supplier to agitate the solution.

The agitator may include a rotational shaft horizontally disposed left and right in the storage unit and blades radially extending from the rotational shaft and having surfaces colliding with the fluids supplied to the storage unit.

The agitator may include a rotational shaft vertically disposed up and down in the storage unit and blades laterally extending from the rotational shaft and having surfaces obliquely colliding with the fluids supplied to the storage unit.

The fluid supplier may include a purge gas supply line supplying purge gas to the storage unit and a solution supply line supplying the solution to the storage unit, wherein the purge gas supply line supplies the purge gas to be opposite to the blades positioned at one side of the rotational shaft, based on the rotational shaft, and the solution supply line supplies the solution to be opposite to the blades positioned at the other side of the rotational shaft.

The fluid supplier may include a purge gas supply line supplying the purge gas to the storage unit and a solution supply line supplying the solution to the storage unit, wherein the purge gas supply line and the solution supply line supplies the purge gas and the solution, respectively, to be opposite to the blades positioned at one side of the rotational shaft, based on the rotational shaft.

The agitator may be driven in a non-vibration manner.

According to another exemplary embodiment of the present invention, there is provided an inkjet printer head assembly, including: a nozzle package discharging ink to printing objects; and an ink tank package combined with the nozzle package and supplying the ink to the nozzle package, wherein the ink tank package includes: a storage unit having an inner space storing the ink; a fluid supplier supplying the purge gas and the ink to the storage unit; and an agitator provided in the storage unit and driven by at least one of the purge gas and the ink supplied to the storage unit from the fluid supplier to agitate the ink.

The inkjet printer head assembly may further include a multi-layer plate structure defining a reservoir receiving the ink, an actuator expanding a supply passage in the multi-layer plate structure to provide a flow pressure to the ink, and a nozzle plate combined with the multi-layer plate structure to receive the ink stored in the reservoir and discharge it to the printing object.

### BRIEF DESCRIPTION OF THE DRAWINGS

FIG. 1 is a diagram showing an inkjet printer head assembly according to an exemplary embodiment of the present invention;

FIGS. 2 and 3 are diagrams for explaining an agitating principle of a solution storage tank shown in FIG. 1;

FIG. 4 is a diagram showing an ink tank package according to a modified example of the present invention; and

FIG. 5 is a diagram showing an ink tank package according to another modified example of the present invention.

### DESCRIPTION OF THE PREFERRED EMBODIMENTS

Various advantages and features of the present invention and methods accomplishing thereof will become apparent from the following description of embodiments with reference to the accompanying drawings. However, the present invention may be modified in many different forms and it should not be limited to the embodiments set forth herein. These embodiments may be provided so that this disclosure will be thorough and complete, and will fully convey the scope of the invention to those skilled in the art. Like reference numerals in the drawings denote like elements.

Terms used in the present specification are for explaining the embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

Hereinafter, a solution storage tank and an inkjet printer head assembly with the same according to an exemplary embodiment of the present invention will be described with reference to the accompanying drawings.

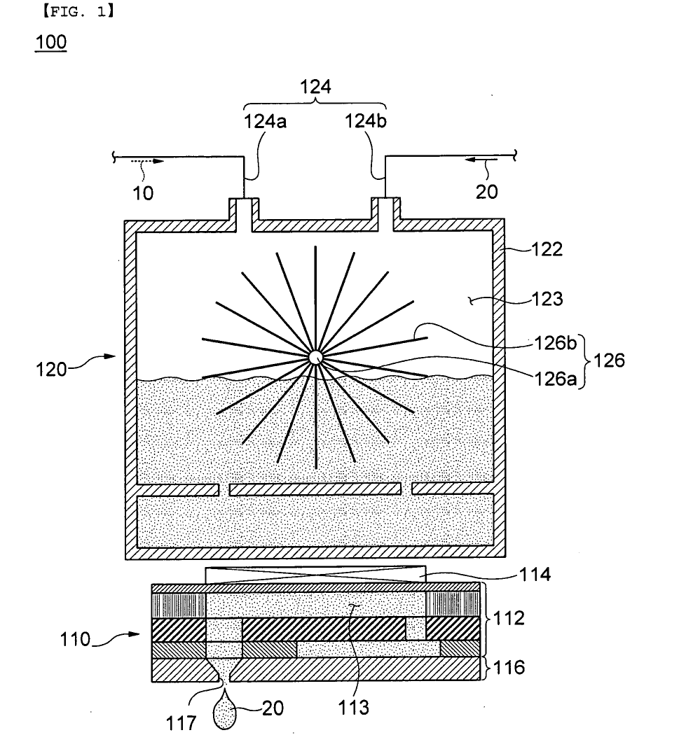

FIG. 1 is a diagram showing an inkjet printer head assembly according to an exemplary embodiment of the present invention. Referring to FIG. 1, an inkjet printer head assembly 100 according to an exemplary embodiment of the present invention may include a nozzle package 110 and an ink tank package 120 combined with the nozzle package 110.

The nozzle package 110 may include a multi-layer plate structure 112, an actuator 114, and a nozzle plate 116, or the like. The multi-layer plate structure 112 may have a structure in which a plurality of plates are stacked. The multi-layer plate structure 112 may be provided with an inner space defining a reservoir 113 receiving ink 20.

The actuator 114 may be disposed on the top portion of the multi-layer plate structure 112. The actuator 114 may be a driver including electrodes and a piezoelectric body disposed between the electrodes. The actuator 114 having the above-mentioned structure applies a predetermined voltage to the electrodes at the time of supplying the ink 20. Therefore, the supply passage in the multi-layer plate structure 112 is expanded by actuating the piezoelectric body, thereby making it possible to provide a flow pressure to the ink 20.

The nozzle plate 116 may be disposed to be combined with the bottom portion of the multi-layer plate structure 112. The nozzle plate 116 may have a discharge hole 117 that is supplied with the ink 20 stored in the reservoir 113 and discharges it to printing objects (not shown).

The ink tank package 120 may be configured to agitate the ink 20 while supplying the ink 20 to the nozzle package 110. To this end, the ink tank package 120 includes at least one solution storage tank storing predetermined solution, wherein the solution storage tank may be configured to agitate the solution. In this configuration, the solution stored and standing-by in the solution storage tank may be the ink 20 for an inkjet printing technology.

The solution storage tank may include a storage unit 122, a fluid supplier 124, and an agitator 126.

The storage unit 122 may include the storage space 123 receiving the ink 20 supplied from the fluid supplier 124 and standing-by it. The storage unit 122 may substantially have a hexahedral or a cylindrical shape.

The fluid supplier 124 may supply a predetermined fluid to the storage unit 122. As one example, the fluid supplier 124 may include a purge gas supply line 124a and an ink supply line 124b. The purge gas supply line 124a may supply a predetermined purge gas 10 to the storage unit 122. An example of the purge gas 10 may include nitrogen (N₂) gas and other various kinds of inert gases. The purge gas 10 may be provided to maintain a pressure in the storage unit 122 to a predetermined pressure. The ink supply line 124b may be a solution supply line supplying the ink 20 to the storage unit 122. In this configuration, the ink supply line 124b may automatically supplement the ink 20 in the storage unit 122 so that the ink 20 in the storage unit 122 meets a predetermined water level.

The agitator 126 may agitate the ink 20 in the storage unit 122. For example, the agitator 126 may include a rotational shaft 126a and blades 126b combined with the rotational shaft 126a. The rotational shaft 126a may be horizontally disposed left and right. The blades 126b may have a structure radially extending from the rotational shaft 126a. The rotational shaft 126a and the blades 126b may substantially have a watermill structure.

The rotational shaft 126a may be disposed in a direction substantially vertical to a supply direction of the purge gas 10 and the ink 20. In addition, the blades 126b may be provided so that the surfaces thereof are opposite to the discharge region of the purge gas 10 and the ink 20 discharged to the inside of the storage unit 122. In this case, the blades 126b are disposed at one side of the rotational shaft 126a to be opposite to the supply region of the purge gas 10 supplied by the purge gas supply line 124a and may be disposed at the other side thereof to be opposite to the supply region of the ink 20 supplied by the ink supply line 124b, based on the rotational shaft 126a. Therefore, the blades 126b collide with the purge gas 10 and the ink 20 supplied to the storage unit 122 to be rotated based on the rotational shaft 126a.

Next, an ink agitating principle of the solution storage tank according to the exemplary embodiment of the present invention will be described in detail. Herein, a description overlapping with the inkjet printer head 100 as described above may be omitted or simplified.

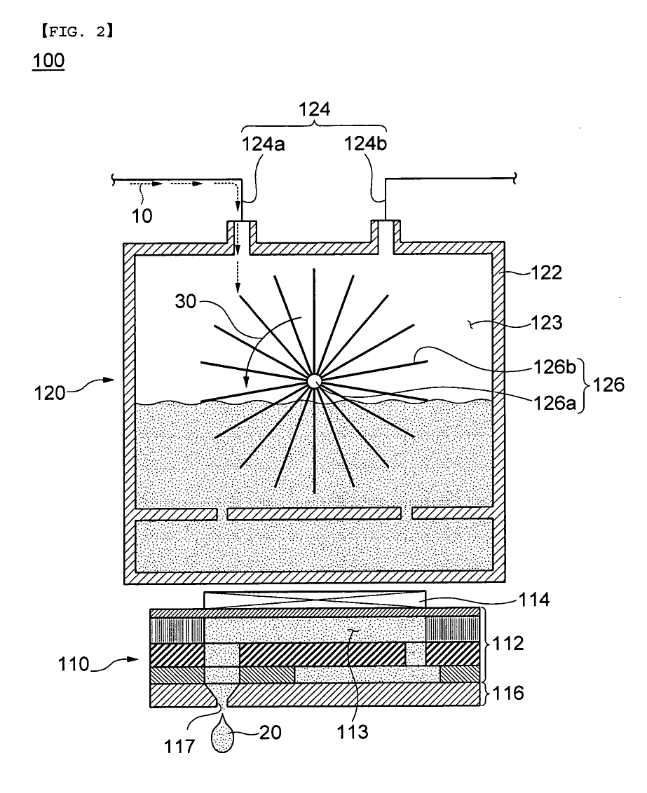

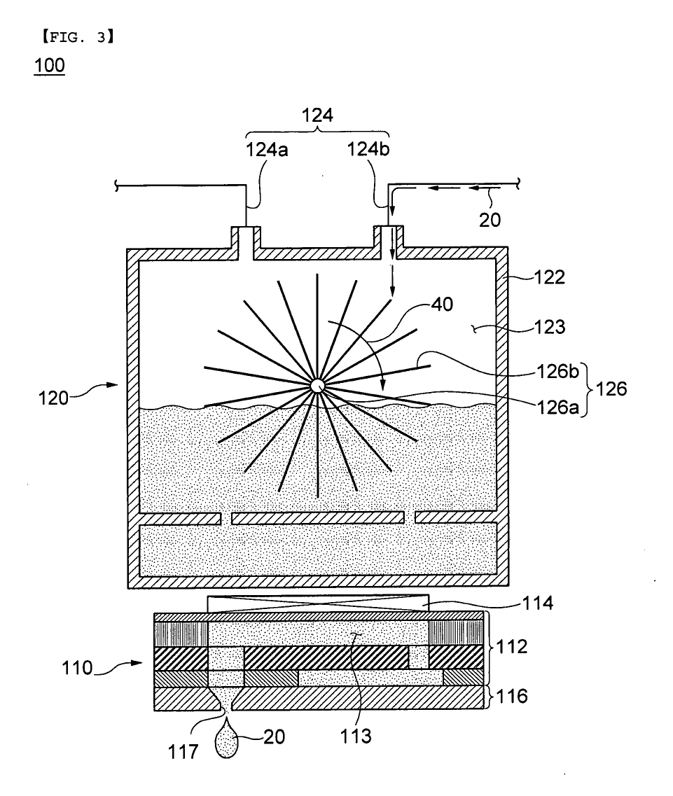

FIGS. 2 and 3 are diagrams for explaining the agitating principle of the solution storage tank shown in FIG. 1. In detail, FIG. 2 is a diagram showing a shape where the ink is agitated by the purge gas and FIG. 3 is a diagram showing a shape where the ink is agitated by the ink.

Referring to FIG. 2, the inkjet printer head assembly 100 may discharge the ink 20 stored in the ink tank package 120 to the printing objects (not shown) through the nozzle package 110. To this end, the storage unit 122 of the ink tank package 120 may maintain the pressure in the storage unit 122 to a predetermined pressure by the purge gas 10 supplied by the purge gas supply line 124a. As described above, the pressure in the storage space 123 of the storage unit 122 is constantly maintained, such that the discharged amount, the discharge precision, or the like, of the ink 20 may be controlled.

Meanwhile, as described above, the agitation of the ink 20 may be performed while the pressure in the storage unit 122 is controlled. For example, the purge gas 10 supplied by the purge gas supply line 124a may be discharged to the blades 126b positioned at one side of the rotational shaft 126a, based on the rotational shaft 126a. To this end, the purge gas supply line 124a may be provided at the top portion of the storage unit 122 so that the purge gas 10 is supplied to the surfaces of the blades 126b positioned at one side of the rotational shaft 126a. Therefore, the agitator 126 is rotated in a first direction 30 by the supply of the purge gas 10, such that the ink 20 may be agitated.

Referring to FIG. 3, the level of the ink 20 in the storage unit 122 is lower than the predetermined level during the supply of the ink as described above, the inkjet printer head assembly 100 may supplement the ink 20 in the ink tank package 120. To this end, the ink supply line 124b of the fluid supplier 124 may supply the ink 20 to the inside of the storage unit 122. The supplemental operation of the ink 20 may be performed in the state where the supply of ink of the inkjet printer head assembly 100 stops. Therefore, the ink 20 may be filled in the storage unit 122. When the ink 20 is filled at the predetermined level, the supply of ink of the inkjet printer head assembly 100 may start.

Meanwhile, as described above, the agitation of the ink 20 may be performed while the ink 20 is filled in the storage unit 122. For example, the ink 20 supplied by the ink supply line 124b may be supplied to the blades 126b positioned at the other side of the rotational shaft 126a, based on the rotational shaft 126a. To this end, the ink supply line 124b may be provided at the top portion of the storage unit 122 so that the ink 20 is supplied to the surfaces of the blades 126b positioned at the other side of the rotational shaft 126a. Therefore, by the supply of the ink 20, the agitator 126 is rotated in a second direction 40 opposite to the first rotational direction 30 of the agitator 126 by the purge gas 10 as described above, such that the ink 20 may be agitated.

As described above, the inkjet printer head assembly 100 according to the exemplary embodiment of the present invention includes the nozzle package 110 and the ink tank package 120, wherein the ink tank package 120 may have a structure in which the ink 20 in the storage unit 122 is agitated by the fluid supplier 124 supplying the purge gas 10 and the ink 20 to the storage unit 122. Therefore, the inkjet printer head assembly according to the present invention can agitate the ink 20 in the storage unit 122 in the non-vibration manner without being affected by the vibration generating sources such as a motor, etc., thereby making it possible to perform efficient agitation of the ink 20 and prevent discharge precision of the ink 20 from being deteriorated due to the agitation operation of the ink 20.

Hereinafter, modified examples of the ink tank package included in the above-mentioned inkjet printer head assembly will be described in detail. In this case, a description overlapping with the ink tank package 120a described with reference to FIGS. 1 to 3 may be omitted.

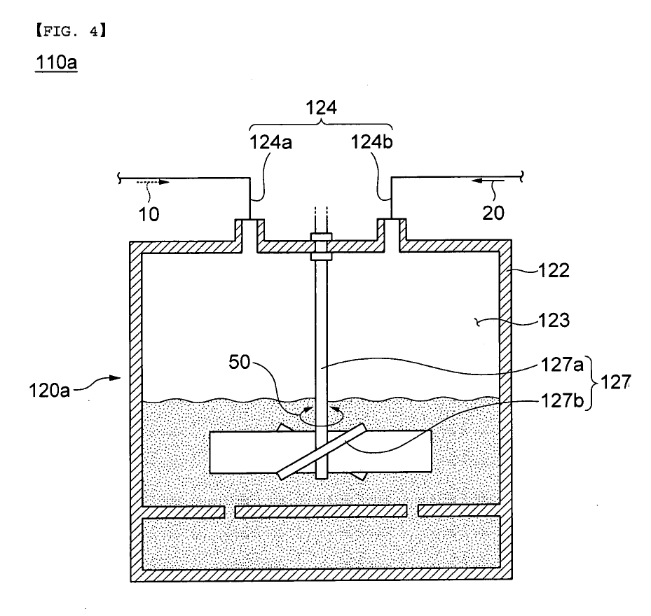

FIG. 4 is a diagram showing an ink tank package according to a modified example of the present invention. Referring to FIG. 4, the ink tank package 120a according to a modified example of the present invention may include the agitator 127 having a horizontal structure, as compared to the ink tank package 120 described with reference to FIGS. 1 to 3.

For example, the agitator 127 may include a rotational shaft 127a vertically disposed up and down in the storage unit 122 and blades 127b laterally extending from the rotational shaft 127a. The rotational shaft 127a may be disposed between the supply portion of the purge gas 10 supplied by the purge gas supply line 124a and the supply portion of the ink 20 supplied by the ink supply line 124b. The blades 127b may be combined with the rotational shaft 127a to be obliquely extended from the rotational shaft 127a. Therefore, the surfaces of the blades 127b may be provided to obliquely collide with the purge gas 10 and the ink 20 supplied to the storage unit 122.

The ink tank package 120 having the above-mentioned structure includes the agitator 127 rotated in the horizontal direction 50 vertical to the first and second directions 30 and 40 shown in FIGS. 1 to 3 so that the agitator 127 may be configured to be rotated by the fluid supplier 124.

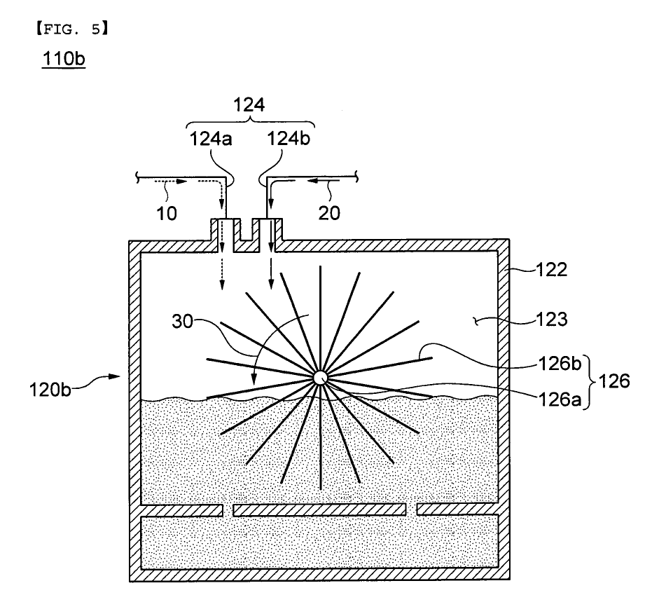

FIG. 5 is a diagram showing an ink tank package according to another modified example of the present invention. Referring to FIG. 5, the ink tank package 120b according to another modified example of the present invention may include the fluid supplier 124 having the structure supplying the purge gas 10 and the ink 20 to the blades 126b at the same position based on the rotational shaft 126a of the agitator 126, as compared to the ink tank package 120 described with reference to FIGS. 1 to 3.

For example, the fluid supplier 124 may include the purge gas supply line 124a and the ink supply line 124b. The purge gas supply line 124a may be connected to the storage unit 122 to supply the purge gas 10 to the blades 126b positioned at one side of the rotational shaft 126a. Similar to the above manner, the ink supply line 124b may be connected to the storage unit 122 to supply the ink 20 to the blades 126b positioned at one side of the rotational shaft 126a. Therefore, the agitator 126 may be configured to be rotated in the first direction 30 by the supply of the purge gas 10 and the ink 20 of the fluid supplier 124.

According to the present invention, the solution storage tank may include the storage unit storing the solution, the agitator agitating the solution in the storage unit, and the fluid supplier supplying the fluid to the storage unit, wherein the agitator may have a structure driven by the fluid supplied from the fluid supplier. Therefore, the solution storage tank according to the present invention agitates the solution in the storage unit by the fluid supplier, thereby making it possible to agitate the solution without requiring separate driving apparatuses, such as a motor, etc.

According to the present invention, the inkjet printer head assembly includes the nozzle package and the ink tank package supplying ink to the nozzle package, wherein the ink tank package may have a structure driving the agitator agitating the ink in the storage unit by the fluid supplier supplying purge gas and ink to the storage unit storing ink. Therefore, the inkjet printer head assembly according to the present invention can agitate the ink in the storage unit in a non-vibration manner without being affected by vibration generating sources such as a motor, etc., thereby making it possible to perform efficient agitation of the ink and prevent discharge precision of the ink from being deteriorated due to the agitating operation of the ink.

The present invention has been described in connection with what is presently considered to be practical exemplary embodiments. Although the exemplary embodiments of the present invention have been described, the present invention may be also used in various other combinations, modifications and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

What is claimed is:

1. A solution storage tank, comprising:
a storage unit having an inner space in which a solution is stored;
a fluid supplier supplying fluid to the storage unit; and
an agitator provided in the storage unit and driven by the fluid supplied to the storage unit from the fluid supplier to agitate the solution.

2. The solution storage tank according to claim 1, wherein the agitator includes:
a rotational shaft horizontally disposed left and right in the storage unit; and
blades radially extending from the rotational shaft and having surfaces colliding with the fluid supplied to the storage unit.

3. The solution storage tank according to claim 1, wherein the agitator includes:
a rotational shaft vertically disposed up and down in the storage unit; and
blades laterally extending from the rotational shaft and having surfaces obliquely colliding with the fluid supplied to the storage unit

4. The solution storage tank according to claim 1, wherein the fluid supplier includes:
a purge gas supply line supplying purge gas to the storage unit; and
a solution supply line supplying the solution to the storage unit,
the purge gas supply line supplying the purge gas to be opposite to the blades positioned at one side of the rotational shaft, based on the rotational shaft, and
the solution supply line supplying the solution to be opposite to the blades positioned at the other side of the rotational shaft.

5. The solution storage tank according to claim 1, wherein the fluid supplier includes:
a purge gas supply line supplying the purge gas to the storage unit; and
a solution supply line supplying the solution to the storage unit,
the purge gas supply line and the solution supply line supplying the purge gas and the solution, respectively, to be opposite to the blades positioned at one side of the rotational shaft, based on the rotational shaft.

6. The solution storage tank according to claim 1, wherein the agitator is driven in a non-vibration manner.

7. An inkjet printer head assembly, comprising:
a nozzle package discharging ink to printing objects; and
an ink tank package combined with the nozzle package and supplying the ink to the nozzle package,
wherein the ink tank package includes:
a storage unit having an inner space storing the ink;
a fluid supplier supplying the purge gas and the ink to the storage unit; and
an agitator provided in the storage unit and driven by at least one of the purge gas and the ink supplied to the storage unit from the fluid supplier to agitate the ink.

8. The inkjet printer head assembly according to claim 7, further comprising:
a multi-layer plate structure defining a reservoir receiving the ink;
an actuator expanding a supply passage in the multi-layer plate structure to provide a flow pressure to the ink; and
a nozzle plate combined with the multi-layer plate structure to receive the ink stored in the reservoir and discharge it to the printing object.

9. The inkjet printer head assembly according to claim 7, wherein the agitator includes:
a rotational shaft horizontally disposed left and right in the storage unit; and
blades radially extending from the rotational shaft and having surfaces colliding with at least one of the purge gas and the ink supplied to the storage unit.

10. The inkjet printer head assembly according to claim 7, wherein the agitator includes:
a rotational shaft vertically disposed up and down in the storage unit; and
blades laterally extending from the rotational shaft and having surfaces obliquely colliding with at least one of the purge gas and the ink supplied to the storage unit.

11. The inkjet printer head assembly according to claim 7, wherein the fluid supplier includes:
a purge gas supply line supplying purge gas controlling a pressure in the storage unit to the storage unit; and
a solution supply line supplying the ink to the storage unit,
the purge gas supply line supplying the purge gas to be opposite to the blades positioned at one side of the rotational shaft, based on the rotational shaft, and
the solution supply line supplying the ink to be opposite to the blades positioned at the other side of the rotational shaft.

12. The inkjet printer head assembly according to claim 7, wherein the fluid supplier includes:
a purge gas supply line supplying purge gas controlling a pressure in the storage unit to the storage unit; and
a solution supply line supplying the ink to the storage unit,
the purge gas supply line and the solution supply line supplying the purge gas and the ink, respectively, to be opposite to the blades positioned at one side of the rotational shaft, based on the rotational shaft.
